(19) United States
(12) Patent Application Publication
(10) Pub. No.: US 2025/0181801 A1
(43) Pub. Date: Jun. 5, 2025

(54) METHOD AND SYSTEM FOR CONSTRUCTING SOIL WATER MOVEMENT MODEL BASED ON PHYSICAL INFORMATION NEURAL NETWORKS

(71) Applicant: China Institute of Water Resources and Hydropower Research, Beijing (CN)

(72) Inventors: Jiaqi ZHAI, Beijing (CN); Tao WANG, Beijing (CN); Yichen ZHAO, Beijing (CN); Haihong LI, Beijing (CN); Kuan LIU, Beijing (CN); Longlong ZHANG, Beijing (CN); Fan HE, Beijing (CN); Xing LI, Beijing (CN); Yong WANG, Beijing (CN)

(73) Assignee: China Institute of Water Resources and Hydropower Research, Beijing (CN)

(21) Appl. No.: 18/773,640

(22) Filed: Jul. 16, 2024

(30) Foreign Application Priority Data
Nov. 30, 2023 (CN) 202311617642.1

(51) Int. Cl. G06F 30/27; G06F 17/13; G06N 3/0499

(52) U.S. Cl. CPC G06F 30/27; G06F 17/13; G06N 3/0499

(57) ABSTRACT

A method and a system for constructing a soil water movement model based on the physical information neural networks are provided. The soil water movement model is constructed by fusing the physical information neural network and a control equation of the soil water movement model, and the model adopts automatic differentiation to replace difference operation of grid scale, so that the calculation error caused by equation discretization in the solving process of numerical differentiation is avoided, and the calculation accuracy is improved; and the automatic differentiation mode is mainly carried out aiming at the output of a neural network, so that the numerical value of gradient calculation is more accurate.

### CROSS REFERENCE TO THE RELATED APPLICATIONS

This application is based upon and claims priority to Chinese Patent Application No. 202311617642.1, filed on Nov. 30, 2023, the entire contents of which are incorporated herein by reference.

### TECHNICAL FIELD

The present disclosure relates to the technical field of soil water movement simulation, in particular to a method and a system for constructing a soil water movement model based on the physical information neural networks.

### BACKGROUND

At present, as a key link in the hydrological process of the basin, on the one hand, interflow directly participates in the formation of runoff, on the other hand, it further dominates the hydrological changes of the basin by affecting the spatial-temporal differences of soil moisture distribution in the basin, and shows high spatial heterogeneity and nonlinearity. How to finely depict the process of interflow movement is the key and difficult point to reveal the mechanism of soil moisture movement and improve the effect of hydrological simulation.

For the Richards equation, the backward Euler scheme is mainly used in the time discretization. An explicit difference scheme based on the forward Euler scheme was proposed by Liu Fengnan et al. The constant coefficient stability term was introduced in the difference scheme, which relaxed the restriction on the time step and improved the stability condition. Mixed finite element method, discontinuous finite element method, characteristic finite element method, finite difference method (FDM), finite element method (FEM) and finite volume method (FVM) are commonly used in spatial discretization. The core of these methods is to reduce the infinite-dimensional operator to a finite-dimensional approximation problem by utilizing some discrete structure, or to introduce new variables to achieve the purpose of simplifying the partial differential equation, or to assume special boundary conditions. However, there are still obvious shortcomings, such as poor generality and difficulty in making a good trade-off between calculation speed and accuracy of results.

In recent years, various deep learning algorithms have performed well in hydrological process simulation, but they have also brought new uncertainties and limitations. For example, generating an accurate surrogate model of a complex mathematical and physical system of hydrological processes usually requires a very large number of data samples, and obtaining such a large number of data from experiments or simulations is often extremely expensive or even infeasible. Physical Informed Neural Networks (PINNs) embed specific prior knowledge into the network model to significantly reduce the complexity of the problem solution space, thus greatly reducing the need for training data (usually only information at the boundary of the spatial-temporal region). Therefore, such a model is constructed to replace the hydrodynamic process modeling governed by PDEs. These physics-embedded “small data” methods essentially provide us with a meshfree algorithm based on automatic differentiation technology. Once these algorithms are trained, given the coordinate information at any resolution in the spatial-temporal region, the algorithm can give quite accurate solution information.

Therefore, how to construct the soil water movement model based on the Physical Informed Neural Networks to solve the poor generality of the calculation method of the Richards equation and balance the calculation speed and result accuracy is an urgent problem to be solved by those skilled in the art.

### SUMMARY

In view of this, the present disclosure provides a method, a method and a system for constructing a soil water movement model based on the physical information neural networks to solve the problems existing in the background.

In order to achieve the above effects, the present disclosure adopts the following technical solutions.

On the one hand, a method for constructing a soil water movement model based on the physical information neural networks is provided, which includes the following steps:
constructing a conventional partial differential equation with constraint conditions and a Richards equation of a one-dimensional soil hydrodynamics model;
outputting an approximate solution of the partial differential equation by utilizing a feedforward neural network;
substituting the approximate solution into the Richards equation through arithmetic operation and automatic differentiation to obtain a residual network;
introducing mean-square error (MSE) to characterize a loss function to evaluate degree of agreement of the approximate solution to the Richards equation, boundary conditions and measured points; and
adopting a one-dimensional soil hydrodynamics model based on the Richards equation with minimum loss function.

Optionally, the Richards equation for the one-dimensional soil hydrodynamics model is

$$C ( h ) \frac{\partial h}{\partial t} = \frac{\partial }{\partial z} [ K ( h ) \frac{\partial h}{\partial z} ] - \frac{\partial K ( h )}{\partial h} \frac{\partial h}{\partial z} - S$$

$$h ( 0 , z ) = {h}_{0} ( z ) , t = 0 , z ⩾ 0$$

$$- K ( h ) \frac{\partial h}{\partial z} + K ( h ) = - ε ( t ) , t > 0 , z = 0$$

$$h ( t , {z}_{0} ) = {h}_{zmax} ( t ) , t > 0 , {z}_{0} = z max$$

Wherein, h is the soil negative pressure, cm; t is the time, min; C (h) is the water capacity when the soil negative pressure is h, cm³·cm⁻³; K (h) is the corresponding water conductivity, cm/min; the intensity of the upper boundary flux is ε(t), cm/min; S is source-sink term, is water absorption intensity of root system at different spatial nodes, and is a function of the spatial location node and the negative pressure h, cm/min; z represents the depth of the spatial node, z max indicates the maximum buried depth, cm; h₀ (z) indicates the initial negative pressure of the soil profile, cm; and h_{zmax}. (t) indicates the negative pressure of the soil profile at the maximum burial depth, cm.

Optionally, the method also includes simplifying the Richards equations of the one-dimensional soil hydrodynamics model into partial differential equations by utilizing the Van Genuchten model.

The Richards equation is simplified by utilizing the Van Genuchten model to only involve partial derivatives of soil negative pressure. The final PINNs form of the Richards equation is expressed as follows:

$$f ( z , t ; \frac{\partial h}{\partial z} , \frac{\partial h}{\partial t} , \frac{{\partial }^{2} h}{\partial {z}^{2}} ; λ ) = C \frac{\partial h}{\partial t} − \frac{\partial K}{\partial h} {( \frac{\partial h}{\partial z} )}^{2} − K \frac{{\partial }^{2} h}{\partial {z}^{2}} − \frac{\partial K}{\partial h} \frac{\partial h}{\partial z} + S = 0$$

Wherein, h is the soil negative pressure, cm; t is the time, min; C (h) is the water capacity when the soil negative pressure is h, cm³·cm⁻³; K (h) is the corresponding water conductivity, cm/min; the intensity of the upper boundary flux is ε(t), cm/min; S is source-sink term, is water absorption intensity of root system at different spatial nodes, and is a function of the spatial location node and the negative pressure h, cm/min; z represents the depth of the spatial node, and λ=[K₈, θ₈, θ_{T}, a, n]^{T} is a parameter vector of the parameterized Richards equation.

Optionally, the Van Genuchten model is expressed as follows:

$$Se ( θ ) = \{ \begin{matrix}1 & h ( θ ) \geq 0 \\ {\{ 1 + {[ {α}_{V G} \vert h \vert ]}^{n} \}}^{− m} & h ( θ ) < 0\end{matrix}$$

$$K ( θ ) = {K}_{s} \sqrt{Se ( θ )} {\{ 1 - {[ 1 - S {e}^{\frac{1}{m}} ( θ ) ]}^{m} \}}^{2}$$

$$θ ( h ) = {θ}_{r} + \frac{{θ}_{s} - {θ}_{r}}{{( 1 + {( - {α}_{V G} h )}^{n} )}^{m}}$$

$$Se ( θ ) = \frac{θ - {θ}_{r}}{{θ}_{s} - {θ}_{r}}$$

Wherein, h is the soil negative pressure, cm; θ is the moisture content, cm³·cm⁻³ θ₈ is the saturation volume moisture content, cm³·cm⁻³; θᵣ is residual moisture content, cm³·cm⁻³; K is unsaturated hydraulic conductivity, cm/min; K₈ is the saturation hydraulic conductivity, cm/min; Se is saturation degree, cm³·cm⁻³; a_{vg} is the shape parameter of the model, which represents the pore size distribution of the soil, cm⁻¹, and n is the soil texture parameter, m=1-1/n.

Optionally, the calculation principle of the automatic differentiation is as follows: decomposing a complex analytic function into a series of elementary operation combinations, performing derivation through symbolic differentiation, substituting related values, storing intermediate results through a computer, and finally obtaining an expected derivative value by utilizing a chain rule.

Optionally, the specific expression of the loss function is constructed by the Richards equation, the boundary conditions and the measured points through the automatic differentiation:

$$ℒ ( π ) = \frac{1}{{N}_{u}} {ω}_{u} {\sum }_{i = 1}^{3} {\sum }_{x ∈ {N}_{u}} {‖ {B}_{i} ( \hat{u} , x ) ‖}_{2}^{2} + \frac{1}{{N}_{f}} {ω}_{f} {\sum }_{x ∈ {N}_{f}} {‖ f ( x ; \frac{\partial u}{\partial {x}_{1}} , … , \frac{\partial u}{\partial {x}_{d}} ; \frac{{\partial }^{2} u}{\partial {x}_{1} \partial {x}_{1}} , … , \frac{{\partial }^{2} u}{\partial {x}_{1} \partial {x}_{d}} ; … ; λ ) ‖}_{2}^{2} + \frac{1}{{N}_{i}} {ω}_{i} {\sum }_{x ∈ {N}_{i}} {‖ ℒ ( \hat{u} , x ) ‖}_{2}^{2}$$

Wherein, [symbol] ᵤ represents the weight of the modified boundary condition loss function; [symbol] _{b} represents the weight of the modified main control equation loss function; [symbol] ᵢ represents the weight of the measured sample point loss functions; B={B₁(Ū_{NN},Z,t), B₂ (Ū_{NN},Z,t), B₃ (Ū_{NN},z,t)}; [symbol] ₁ (Ū_{NN}, Z,t)=Ū_{NN} (z, 0)−h(z, 0) is the initial condition of the control equation, and [symbol] ₂ (Ū_{NN}, z,t)=−K(h) ∂h(Ū_{NN}, t)/∂z+K(h)+ε(t) and [symbol] ₃ (Ū_{NN},Z,t)=Ū_{NN} (zmax, 0)−h (zmax, 0) are the upper and lower flux boundary conditions of the control equation; Nᵤ and N_{f} represent the set of residual points for training the neural network in the boundary and the calculation area, which can be selected by random sampling, and Nᵢ is the set composed of measured data.

Optionally, the obtained residual network is as follows:

$${f}_{NN} ( x ; π ) = ( x ; \frac{\partial {u}_{NN}}{\partial {x}_{1}} , … , \frac{\partial {u}_{NN}}{\partial {x}_{d}} , \frac{{\partial }^{2} {u}_{NN}}{\partial {x}_{1} \partial {x}_{1}} , … , \frac{{\partial }^{2} {u}_{NN}}{\partial {x}_{1} \partial {x}_{d}} ; … )$$

Wherein, x=(x₁, x₂, . . . , xₐ) represents the variable of the partial differential equation, U_{NN} is the partial derivative of x, and u(x) satisfies the boundary condition:

[symbol]

(u,x)=0,x∈∂Ω.

On the other hand, a system for constructing a soil water movement model based on the physical information neural networks is provided, which includes the following modules:
an equation construction module, configured to construct a conventional partial differential equation with constraint conditions and a Richards equation of a one-dimensional soil hydrodynamics model;
a solving module, configured to output an approximate solution of the partial differential equation by utilizing a feedforward neural network;
a residual network acquisition module, configured to substitute the approximate solution into the Richards equation through arithmetic operation and automatic differentiation to obtain a residual network;
an evaluation module, configured to introduce mean-square error (MSE) to characterize the loss function to evaluate the degree of agreement of the approximate solution to the Richards equation, boundary conditions and measured points; and
a model output module, configured to adopt a one-dimensional soil hydrodynamics model based on the Richards equation with minimum loss function.

According to the technical solutions, compared with the prior art, a method and a system for constructing a soil water movement model based on the physical information neural networks disclosed and provided by the present disclosure adopt automatic differentiation to replace difference operation of grid scale, so that the calculation error caused by equation discretization in the solving process of numerical differentiation is avoided, and the calculation accuracy is improved; and the automatic differentiation mode is mainly carried out aiming at the output of a neural network, so that the numerical value of gradient calculation is more accurate.

### BRIEF DESCRIPTION OF THE DRAWINGS

In order to more clearly illustrate the embodiments of the present disclosure or technical solutions in the related art, the accompanying drawings used in the embodiments or the related art will now be described briefly. It is obvious that the drawings in the following description are only the embodiment of the disclosure, and that those skilled in the art can obtain other drawings from these drawings without any creative efforts.

FIG. 1 is a schematic diagram of the model construction provided by the present disclosure;

FIG. 2 is a simulation result of the model provided by the present disclosure;

FIG. 3A shows the simulation effect of the model with a measured depth of 200 cm provided by the present disclosure;

FIG. 3B shows the simulation effect of the model with a measured depth of 140 cm provided by the present disclosure;

FIG. 3C shows the simulation effect of the model with a measured depth of 80 cm provided by the present disclosure;

FIG. 3D shows the simulation effect of the model with a measured depth of 20 cm provided by the present disclosure;

FIG. 3E shows the simulation effect of the model with a measured depth of 800 cm provided by the present disclosure;

FIG. 3F shows the simulation effect of the model with a measured depth of 400 cm provided by the present disclosure;

FIG. 4 is a schematic diagram of water balance at a buried depth of 2 m provided by the present disclosure;

FIG. 5A is the water capacity curve of the dry soil infiltration process provided by the present disclosure;

FIG. 5B is the hydraulic conductivity curve of the dry soil infiltration process provided by the present disclosure;

FIG. 6 is a schematic diagram of a model for simulating a dry soil infiltration process provided by the present disclosure;

FIG. 7 is a schematic diagram showing the comparison between the simulation solution and the exact solution provided by the present disclosure; and

FIG. 8 is a flow chart of the model construction method provided by the present disclosure.

### DETAILED DESCRIPTION OF THE EMBODIMENTS

In the following, the technical solutions in the embodiments of the present disclosure will be clearly and completely described with reference to the drawings in the embodiments of the present disclosure. Obviously, the described embodiments are only a part of the embodiments of the present disclosure, but not all the embodiments thereof. Based on the embodiments of the present disclosure, all other embodiments obtained by those skilled in the art without any creative efforts shall fall within the scope of the present disclosure.

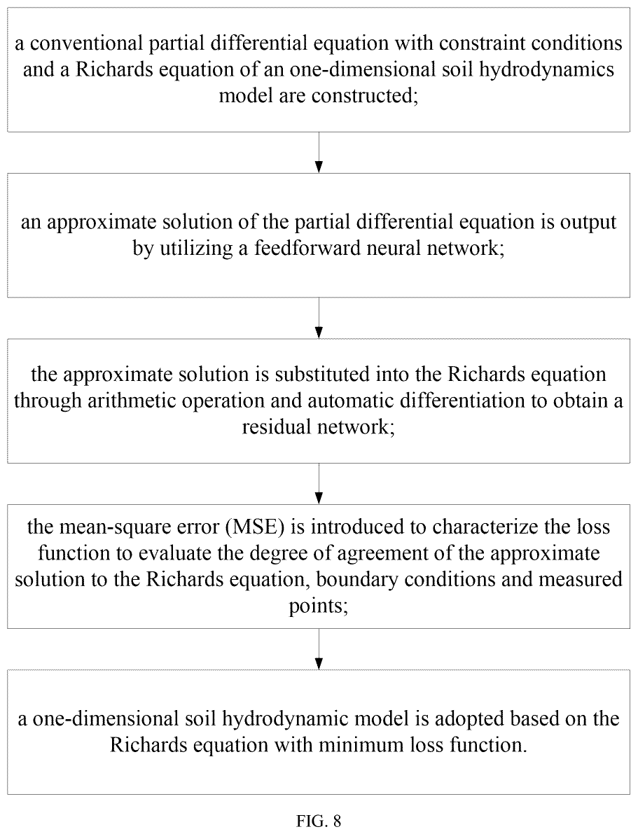

On the one hand, the embodiment of the present disclosure discloses a method for constructing a soil water movement model based on the physical information neural networks, as shown in FIG. 8, including the following steps:
a conventional partial differential equation with constraint conditions and a Richards equation of a one-dimensional soil hydrodynamics model are constructed;
an approximate solution of the partial differential equation is output by utilizing a feedforward neural network;
the approximate solution is substituted into the Richards equation through arithmetic operation and automatic differentiation to obtain a residual network;
the mean-square error (MSE) is introduced to characterize the loss function to evaluate the degree of agreement of the approximate solution to the Richards equation, boundary conditions and measured points; and
a one-dimensional soil hydrodynamics model is adopted based on the Richards equation with minimum loss function.

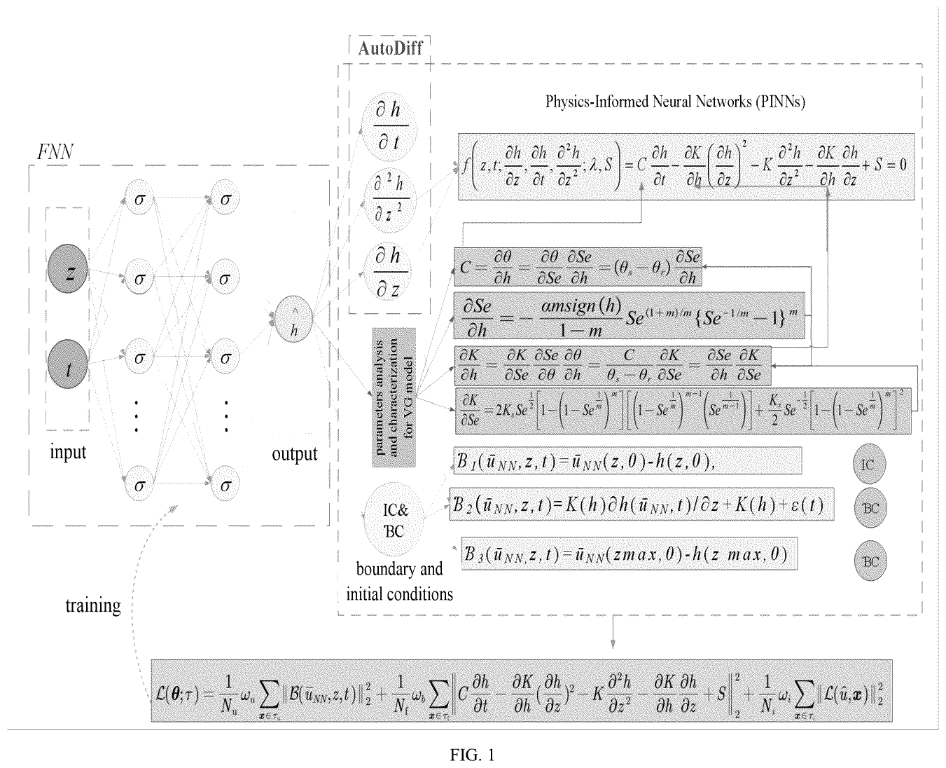

The schematic diagram of the model construction of the present disclosure is shown in FIG. 1.

In a specific embodiment, according to a general definition, in the computational domain Ω⊏ [symbol] ^{d}, the partial differential equation with the constraint conditions can be represented by the following form:

$$f ( x ; \frac{\partial u}{\partial {x}_{1}} , … , \frac{\partial u}{\partial {x}_{d}} ; \frac{{\partial }^{2} u}{\partial {x}_{1} \partial {x}_{1}} , … , \frac{{\partial }^{2} u}{\partial {x}_{1} \partial {x}_{d}} ; … ; λ ) = 0 , x ∈ Ω$$

Wherein, x=(x₁, x₂, . . . , xₐ) and λ=(λ₁, λ₂, . . . , λₐ) respectively represent the variable and the parameter of the partial differential equation, and u(x) satisfies the boundary condition:

[symbol]

(u,x)=0,x∈∂Ω

Wherein, [symbol] (u,x) can be Dirichlet boundary conditions, Neumann boundary conditions, or periodic boundary conditions. u is the solution of the partial differential equation; for problems involving the time variable, the time t can be regarded as a special component of x, the time domain is included in Ω, and the initial condition is regarded as a special type of Dirichlet boundary condition on the spatial-temporal domain.

When solving the PINNs algorithm, an approximate solution U_{NN} (x;θ) of a partial differential equation u(x) is output by using a Feedforward Neural Network (FNN), wherein a parameter θ is a combination of a bias vector and a weight matrix; U_{NN} is the partial derivative of x, which can be solved by built-in automatic differentiation modules such as deep learning framework TensorFlow or PyTorch. Wherein Automatic Differentiation (AD) is a method between symbolic differentiation and numerical differentiation, and its calculation principle is to decompose a complex analytic function into a series of elementary operation combinations, calculate the derivative through symbolic differentiation, then bring in the related values, store the intermediate results through the computer, and finally obtain the expected derivative value by utilizing the chain rule. Therefore, compared with numerical differentiation, automatic differentiation can replace the difference operation of grid scale, avoid the calculation error caused by the equation discretization in the solving process of numerical differentiation, and improve the calculation accuracy, and the way of automatic differentiation is mainly aimed at the output of neural network, which makes the numerical value of gradient calculation more accurate.

In the training process of PINNs network, the determination of the training set T is the most critical, which mainly covers the configuration of two groups of points: one group of data points is taken from the initial boundary Tᵤ={(xᵤ⁽ⁱ⁾, u(xᵤ⁽ⁱ⁾))}ᵢ₌₁^{N}^{ᵤ}, and the other group is the configuration point T_{f}={(x_{f}⁽ⁱ⁾, u(x_{f}⁽ⁱ⁾))}ᵢ₌₁^{N}^{ᵤ} representing the whole spatial-temporal domain. The residual network is obtained by substituting the surrogate model U_{NN} into the physical governing equations through arithmetic operations and automatic differentiation:

$${f}_{NN} ( x ; π ) = ( x ; \frac{\partial {u}_{NN}}{\partial {x}_{1}} , … , \frac{\partial {u}_{NN}}{\partial {x}_{d}} , \frac{{\partial }^{2} {u}_{NN}}{\partial {x}_{1} \partial {x}_{1}} , … , \frac{{\partial }^{2} {u}_{NN}}{\partial {x}_{1} \partial {x}_{d}} ; … )$$

In order to evaluate the coincidence degree of U_{NN} (x;θ) with the physical governing equations, boundary conditions and measured points, the mean-square error (MSE) is introduced to characterize the loss function. The loss function consists of three parts, the first part is used to evaluate how well the surrogate model satisfies the known initial boundary conditions, the second part is used to evaluate how well the surrogate model satisfies the physical governing equations in the domain, and the third part is the measured point loss function:

$$ℒ ( π ) = \frac{1}{{N}_{u}} {ω}_{u} {\sum }_{i = 1}^{3} {\sum }_{x ∈ {N}_{u}} {‖ {ℬ}_{i} ( \hat{u} , x ) ‖}_{2}^{2} + \frac{1}{{N}_{f}} {ω}_{f} {\sum }_{x ∈ {N}_{f}} {‖ f ( x ; \frac{\partial u}{\partial {x}_{1}} , … , \frac{\partial u}{\partial {x}_{d}} ; \frac{{\partial }^{2} u}{\partial {x}_{1} \partial {x}_{1}} , … , \frac{{\partial }^{2} u}{\partial {x}_{1} \partial {x}_{d}} ; … ; λ ) ‖}_{2}^{2} + \frac{1}{{N}_{i}} {ω}_{i} {\sum }_{x ∈ {N}_{i}} {‖ ℒ ( \hat{u} , x ) ‖}_{2}^{2}$$

Wherein, [symbol] ᵤ represents the weight of the modified boundary condition loss function; [symbol] _{b} represents the weight of the modified main control equation loss function; [symbol] ᵢ represents the weight of the measured sample point loss functions; ∥·∥₂ represents the Euclidean norm, Nᵤ and N_{f} represent the set of residual points for training the neural network in the boundary and the calculation area, which can be selected by random sampling, Nᵢ is the set composed of measured data, and [symbol] ᵢ(û,x) represents the simulation result at the boundary.

In a specific embodiment, the Richards equation for the one-dimensional soil hydrodynamics model is:

$$C ( h ) \frac{\partial h}{\partial t} = \frac{\partial }{\partial z} [ K ( h ) \frac{\partial h}{\partial z} ] - \frac{\partial K ( h )}{\partial h} \frac{\partial h}{\partial z} - S$$

$$h ( 0 , z ) = {h}_{0} ( z ) , t = 0 , z ⩾ 0$$

$$- K ( h ) \frac{\partial h}{\partial z} + K ( h ) = - ε ( t ) , t > 0 , z = 0$$

$$h ( t , {z}_{0} ) = {h}_{zmax} ( t ) , t > 0 , {z}_{0} = z max$$

Wherein, h is the soil negative pressure, cm; t is the time, min; C(h) is the water capacity when the soil negative pressure is h, cm³·cm⁻³; K(h) is the corresponding water conductivity, cm/min; the intensity of the upper boundary flux is ε(t), cm/min; S is source-sink term, is water absorption intensity of root system at different spatial nodes, and is a function of the spatial location node and the negative pressure h, cm/min; z represents the depth of the spatial node, z max indicates the maximum buried depth, cm; h₀(z) indicates the initial negative pressure of the soil profile, cm; and h_{zmax} (t) indicates the negative pressure of the soil profile at the maximum burial depth, cm.

In a specific embodiment, the method also includes simplifying the Richards equations of the one-dimensional soil hydrodynamics model into partial differential equations by utilizing the Van Genuchten model.

In order to make the PINNs algorithm simulate the Richards equation more accurately, C(h) and ∂K/∂h in the Richards equation need to be transformed, and only the partial derivative of the soil negative pressure is retained to adapt to the solution. In the formula, C (h)=∂θ/∂h is called water capacity (or specific water capacity) and represents the change in moisture content per unit change in soil negative pressure. The water capacity was further analyzed by Van Genuchten model.

$$C = \frac{\partial θ}{\partial h} = \frac{\partial θ}{\partial Se} \frac{\partial Se}{\partial h} = ( {θ}_{s} - {θ}_{r} ) \frac{\partial Se}{\partial h}$$

Wherein, Se is the saturation, Se=(θ−θᵣ)/(σₛ−θᵣ).

Further decomposition of ∂Se/∂h is:

$$\frac{\partial Se}{\partial h} = - \frac{α m sign ( h )}{1 - m} S {e}^{( 1 + m ) / m} {\{ {Se}^{( - 1 / m} - 1 \}}^{m}$$

Similarly, ∂K/∂h in the Richards equation can also be characterized analytically:

$$\frac{\partial K}{\partial h} = \frac{\partial K}{\partial Se} \frac{\partial Se}{\partial θ} \frac{\partial θ}{\partial h} = \frac{C}{{θ}_{s} − {θ}_{r}} \frac{\partial K}{\partial Se} = \frac{\partial Se}{\partial h} \frac{\partial K}{\partial Se}$$

Wherein, the analytical method for ∂Se/∂θ=1/(θₛ−θᵣ) and ∂K/∂Se is calculated as follows:

$$\frac{\partial K}{\partial Se} = 2 {K}_{s} S {e}^{\frac{1}{2}} [ 1 - {( 1 - S {e}^{\frac{1}{m}} )}^{m} ] [ {( 1 - S {e}^{\frac{1}{m}} )}^{m - 1} ( S {e}^{\frac{1}{m} - 1} ) ] + \frac{{K}_{s}}{2} S {e}^{− \frac{1}{2}} {[ 1 − {( 1 − S {e}^{\frac{1}{m}} )}^{m} ]}^{2}$$

After treatment, the Richards equation only involves three partial derivatives of soil negative pressure h, namely ∂h/∂z, ∂h/∂t and ∂²h/∂z², which reflect the spatial gradient of moisture content affected by the spatial variation of parameters. Combined with Van Genuchten model, C(h) and ∂K/∂h can be calculated by analytical method. To sum up, the PINNs form of the Richards equation can be expressed as follows:

$$f ( z , t ; \frac{\partial h}{\partial z} , \frac{\partial h}{\partial t} , \frac{{\partial }^{2} h}{\partial {z}^{2}} ; λ ) = C \frac{\partial h}{\partial t} − \frac{\partial K}{\partial h} {( \frac{\partial h}{\partial z} )}^{2} − K \frac{{\partial }^{2} h}{\partial {z}^{2}} − \frac{\partial K}{\partial h} \frac{\partial h}{\partial z} + S = 0$$

Wherein, λ=[Kₛ, θₛ, θᵣ, a, n]^{T} is a parameter vector of the parameterized Richards equation, h is the soil negative pressure, cm; t is the time, min; C(h) is the water capacity when the soil negative pressure is h, cm³·cm⁻³; K (h) is the corresponding water conductivity, cm/min; the intensity of the upper boundary flux is ∈(t), cm/min; S is source-sink term, is water absorption intensity of root system at different spatial nodes, and is a function of the spatial location node and the negative pressure h, cm/min; z represents the depth of the spatial node, and λ=[Kₛ, θₛ, θᵣ, a, n]^{T} is a parameter vector of the parameterized Richards equation.

In a specific embodiment, the Van Genuchten model is expressed as follows:

$$Se ( θ ) = \{ \begin{matrix}1 & h ( θ ) \geq 0 \\ {\{ 1 + {[ {α}_{V G} \vert h \vert ]}^{n} \}}^{− m} & h ( θ ) < 0\end{matrix}$$

$$K ( θ ) = {K}_{s} \sqrt{Se ( θ )} {\{ 1 - {[ 1 - S {e}^{\frac{1}{m}} ( θ ) ]}^{m} \}}^{2}$$

$$θ ( h ) = {θ}_{r} + \frac{{θ}_{s} - {θ}_{r}}{{( 1 + {( - {α}_{V G} h )}^{n} )}^{m}}$$

$$Se ( θ ) = \frac{θ - {θ}_{r}}{{θ}_{s} - {θ}_{r}}$$

Wherein, h is the soil negative pressure, cm; θ is the moisture content, cm³·cm⁻³; θₛ is the saturation volume moisture content, cm³·cm⁻³; θᵣ is residual moisture content, cm³·cm⁻³; K is unsaturated hydraulic conductivity, cm/min; Kₛ is the saturation hydraulic conductivity, cm/min; Se is saturation degree, cm³·cm⁻³; a_{VG} is the shape parameter of the model, which represents the pore size distribution of the soil, cm⁻¹, and n is the soil texture parameter, m=1−1/n.

In a specific embodiment, the calculation principle of the automatic differentiation is as follows: decomposing a complex analytic function into a series of elementary operation combinations, performing derivation through symbolic differentiation, substituting related values, storing intermediate results through a computer, and finally obtaining an expected derivative value by utilizing a chain rule.

In a specific embodiment, the specific expression of the loss function is constructed by the Richards equation, the boundary conditions and the measured points through automatic differentiation:

$$ℒ ( \prod ) = \frac{1}{{N}_{u}} {ω}_{u} {\sum }_{i = 1}^{3} {\sum }_{x ∈ {N}_{u}} {‖ {ℬ}_{i} ( \hat{u} , x ) ‖}_{2}^{2} + \frac{1}{{N}_{f}} {ω}_{f} {\sum }_{x ∈ {N}_{f}} {‖ f ( x ; \frac{\partial u}{\partial {x}_{1}} , … , \frac{\partial u}{\partial {x}_{d}} ; \frac{{\partial }^{2} u}{\partial {x}_{1} \partial {x}_{1}} , … , \frac{{\partial }^{2} u}{\partial {x}_{1} \partial {x}_{d}} ; … ; λ ) ‖}_{2}^{2} + \frac{1}{{N}_{i}} {ω}_{i} {\sum }_{x ∈ {N}_{i}} {‖ ℒ ( \hat{u} , x ) ‖}_{2}^{2}$$

Wherein, [symbol] ᵤ represents the weight of the modified boundary condition loss function; [symbol] _{b} represents the weight of the modified main control equation loss function; [symbol] ᵢ represents the weight of the measured sample point loss functions; B={B₁ (Ū_{NN},Z,t), B₂ (Ū_{NN},z,t), B₃ (U_{NN}, z,t)}; [symbol] ₁ (Ū_{NN},Z,t)=Ū_{NN} (z, 0)−h(z, 0) is the initial condition of the control equation, and [symbol] ₂ (Ū_{NN},z,t)=−K(h)∂h(Ū_{NN}, t)/∂z+K (h)+ε(t) and [symbol] ₃ (Ū_{NN},Z,t)=Ū_{NN} (zmax, 0)−h(zmax, 0) are the upper and lower flux boundary conditions of the control equation; Nᵤ and N_{f} represent the set of residual points for training the neural network in the boundary and the calculation area, which can be selected by random sampling, and Nᵢ is the set composed of measured data.

In a specific embodiment, In order to verify the reliability of the application of the PINNs algorithm in the simulation of vertical infiltration of water in layered soil in a non-laboratory environment, the present disclosure simulates the water movement process in the vadose zone of deep soil, and compares and verifies the observation data of soil water infiltration recharge in a test station.

The PINNs algorithm was applied to a field layered soil simulation experiment to test the computational accuracy of the PINNs algorithm in simulating the Richards equation with h as the main variable. On the basis of setting the parameters of soil stratification, the loss function constructed by 2047 measured points obtained in the simulation period (from Apr. 12, 2012 to Sep. 30, 2012) is used as the training sample of the model. The parameters of the soil moisture characteristic curve adopted are obtained by the team based on the analysis of the measured data of Luancheng Experimental Station, and the relevant values are shown in Table 1. According to the method, the gradual drying process of the soil after effective precipitation is used as the basis for calibrating the soil water parameters, and the negative pressure and moisture content data of the soil monitored in multiple layers are used for calibrating layer by layer.

TABLE 1
Parameters of Soil moisture Characteristic
Curve in Luancheng Experimental Station

| Depth | | | | | | |
|---|---|---|---|---|---|---|
| of soil | | θs | θr | Ks | α | |
| layer/m | Type of soil | cm³/cm³ | cm³/cm³ | cm/min | cm⁻¹ | n |
| 0-0.9 | Sandy loam | 0.36 | 0.09 | 0.012 | 0.010 | 1.33 |
| 0.9-1.1 | Silty clay | 0.37 | 0.10 | 0.015 | 0.028 | 1.29 |
| | loam | | | | | |
| 1.1-1.6 | Sandy loam | 0.33 | 0.07 | 0.007 | 0.023 | 1.30 |
| 1.6-2.8 | Silty clay | 0.40 | 0.15 | 0.005 | 0.010 | 1.30 |
| | loam | | | | | |
| 2.8-3.2 | Sandy loam | 0.39 | 0.14 | 0.016 | 0.018 | 1.26 |
| 3.2-3.8 | Silty loam | 0.39 | 0.11 | 0.08 | 0.017 | 1.26 |
| 3.8-5.2 | Sandy loam | 0.37 | 0.11 | 0.012 | 0.018 | 1.18 |
| 5.2-7.8 | Sandy soil | 0.3 | 0.05 | 0.4 | 0.026 | 2.2 |
| 7.8-8.8 | Sandy loam | 0.31 | 0.06 | 0.05 | 0.04 | 1.8 |
| 8.8-9.4 | Silty loam | 0.41 | 0.10 | 0.009 | 0.009 | 1.32 |
| 9.4-10 | Sandy loam | 0.38 | 0.09 | 0.04 | 0.009 | 1.35 |
| 10-12 | Silty clay | 0.40 | 0.14 | 0.006 | 0.024 | 1.28 |
| | loam | | | | | |
| 12-13 | Silty loam | 0.40 | 0.13 | 0.05 | 0.011 | 1.35 |
| 13-14.2 | Sandy loam | 0.38 | 0.08 | 0.04 | 0.010 | 1.34 |
| 14.2-16.4 | Sandy soil | 0.31 | 0.05 | 0.3 | 0.030 | 2.1 |
| 16.4-20.2 | Silty loam | 0.41 | 0.13 | 0.08 | 0.012 | 1.3 |
| 20.2-21.4 | Sandy loam | 0.37 | 0.05 | 0.025 | 0.011 | 1.42 |
| 21.4-25.4 | Silty clay | 0.39 | 0.13 | 0.006 | 0.019 | 1.31 |
| | loam | | | | | |
| 25.4-29 | Silty loam | 0.39 | 0.11 | 0.08 | 0.017 | 1.26 |
| 29-30.2 | Sandy loam | 0.37 | 0.11 | 0.04 | 0.009 | 1.8 |
| 30.2-31.2 | Silty loam | 0.40 | 0.13 | 0.08 | 0.012 | 1.26 |
| 31.2-33.4 | Sandy loam | 0.38 | 0.09 | 0.04 | 0.009 | 1.35 |
| 33.4-42 | Silty loam | 0.39 | 0.12 | 0.05 | 0.011 | 1.36 |
| 42-43.6 | Sandy loam | 0.38 | 0.08 | 0.04 | 0.010 | 1.34 |
| 43.6-45.2 | Silty loam | 0.39 | 0.12 | 0.03 | 0.011 | 1.33 |

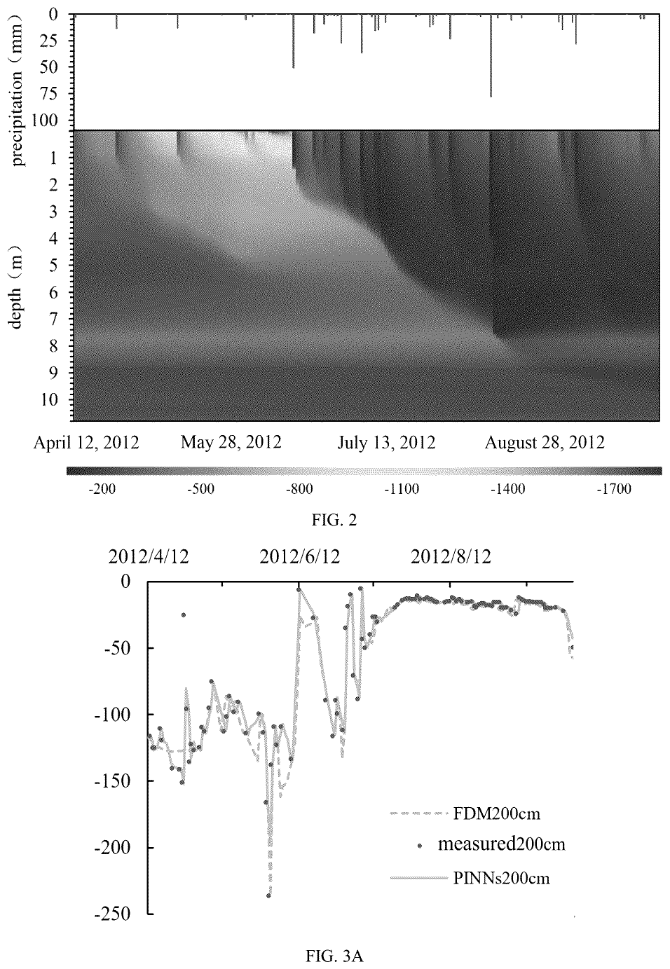

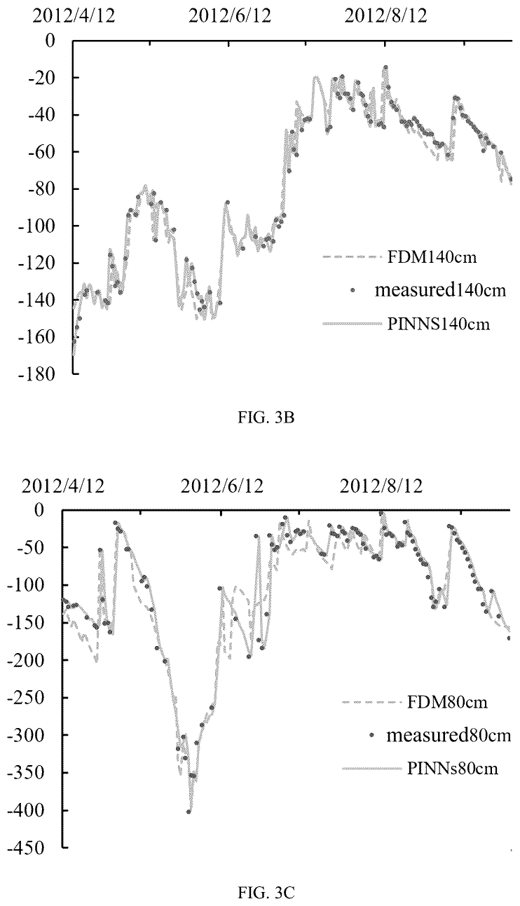

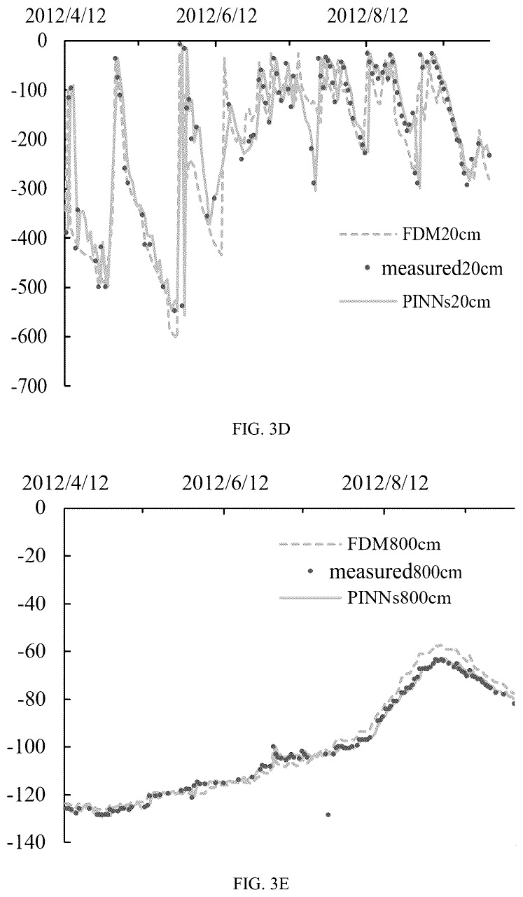

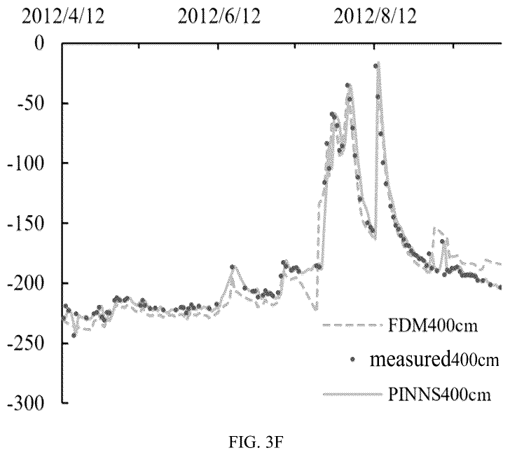

The second boundary condition (Neumann condition) is used in the upper boundary of the model simulation, that is, given the flux boundary, the flux is the evaporation of topsoil or the precipitation and irrigation amount. The first boundary condition (Dirichlet condition) is used for the lower boundary, that is, the negative pressure of the water table is used as the lower boundary for the given water head boundary. The PINNs algorithm is written in Python and run in the Pycharm integrated development environment, the weight of the modified loss term is set to 1, and the Adam algorithm and the L-BFGS-B algorithm with a learning rate of 0.001 and an iteration step number of 20000 are used as the optimization algorithm, that is, after the Adam algorithm is used to iterate to the specified step number, then L-BFGS-B is used for optimization, which can improve the calculation accuracy and efficiency. The simulation results and model simulation effects obtained based on the PINNs algorithm are shown in FIG. 2 and FIGS. 3A-3E. The finite difference method is based on the one-dimensional soil hydrodynamics model in the deep buried area.

FIGS. 3A-3E show the simulation effect of PINNs algorithm, and the changes of soil negative pressure predicted by the two methods are relatively consistent. Compared with the numerical simulation results, the NS efficiency coefficient of each layer of soil in the PINNs algorithm is 0.92, and the NS efficiency coefficient of each layer of soil in the FDM numerical solution is 0.84, which shows that the use of PINNs to solve the soil water infiltration problem in the field environment can achieve the same accuracy as the traditional numerical method. If the number of iteration steps reaches 6500, the model tends to converge, and the training time of the network is 192.6 seconds, and the finite difference algorithm calculation is 808.8 seconds. PINNs has a significant advantage in terms of training time. At the same time, the simulation results show that there is a relatively rapid alternation process from unsaturated state to saturated state in the upper 1 m of the model, and the variation amplitude of soil water potential is relatively large. The change of soil water potential in deep soil layer was small. Compared with the finite difference algorithm, the PINNs algorithm has better adaptability to the large water potential gradient difference in the simulation of rainfall infiltration recharge in the surface dry-wet alternation soil, and its predicted value is in good agreement with the measured value, and the curve is smoother, which shows the ability of PINNs algorithm to predict and simulate the highly nonlinear process. However, due to the high nonlinearity of the Richards equation, it is necessary to adjust the initial parameter settings to ensure the convergence of the solution.

On the basis of the above grid configuration, in order to verify whether the PINNs have the fast calculation ability to fine-tune the soil layer parameters, the parameter values of the soil water characteristic curve of 2.8 m-3.2 m soil layer are changed (the same parameter values as the upper layer are adopted), and the sampling calculation is carried out again on the basis of the PINNs that have been trained and converged. The average error of the solution compared with the numerical simulation is 2.43%. However, the convergence time of the new calculation is only 10.6 seconds, which shows that PINNs can reach the same level as the numerical simulation method in the simulation of partial differential equations, and is an effective alternative and verification scheme. Its advantages are that it can adapt to the condition assignment of complex non-uniform boundaries and achieve fast convergence when the design conditions are fine-tuned.

When the model is trained, a feedforward neural network FNN (z, t; II) with z and t as input values and ĥ as an output value is firstly constructed, so that an approximate solution of a main control equation can be obtained; then a certain amount of residual points are taken from initial conditions, boundary conditions and the main control equation to construct a loss function, so that the problem is converted into an optimization problem; finally, the gradient optimization algorithm is adopted to minimize the loss function, thus the parameter II* is obtained, and this process is called “training”. A neural network model embedded with Richards equation is trained to describe the process of soil moisture movement from the input 2, 4 to the output Â Compared with the traditional numerical methods for solving the Richards equation, such as the finite difference method and the finite element method, the significant advantage of the proposed method is that it does not impose any restrictions on the sampling data points, and the traditional method usually leads to a decrease in the computational time due to the node distribution or mesh quality, especially when solving high-dimensional complex problems. The PINNs method based on automatic differentiation technique avoids this problem.

In a specific example, the reliability of the simulation of PINNs algorithm is discussed by taking the conservation of mass conservation problem and the dry soil infiltration problem which are two classical problems solved by finite difference method as examples.

### 1) Mass Conservation Problem

Due to the strong nonlinear characteristics of the saturated-unsaturated soil moisture movement equation, in the traditional numerical solution, the time derivative term is generally required to be specially treated, and improper treatment will cause quality errors, and the solution process requires iterative calculation, and the computational cost and stability are also a major concern. The following formula describes the water mass conservation relation obtained by expanding the unit volume medium at any point by utilizing the Euler implicit scheme and the Rolle theorem:

$$\frac{\partial θ}{\partial t} = C \frac{\partial h}{\partial t} = {C}^{j + α} \frac{{h}^{j + 1} - {h}^{j}}{Δ t} + o ( Δ t )$$

Wherein, θ is the moisture content, cm³·cm⁻³; h is the soil negative pressure, cm; t is the time, min; C(h) is the water capacity when the soil negative pressure is h, cm³·cm⁻³;^{∂} is a constant, taking the value 0-1; j is a constant, used to mark the time; o(Δt) is the remainder of the difference.

That is to say, the change of water content (representing the rate of change of unsaturated zone mass) can be expressed by the water head of two time periods, but it is necessary to find the water capacity of a special time (t=t^{j+a}, where a∈(0, 1)) to make the formula valid. However, a is related to the variable h^{j+1} to be evaluated, and its value cannot be determined before solving the equation. Therefore, a=0 (explicit scheme), 1/2 (leapfrog scheme) or 1 (implicit scheme) are often used instead in numerical calculation, which often leads to the mass conservation problem. Experiments show that the mass error can be eliminated only when the time step is infinitely small. Due to the severe quality error, the time discretization is performed in the following two ways:

$$\frac{\partial θ}{\partial t} \approx \frac{{θ}^{j + 1 , k + 1} - {θ}^{j}}{Δ t} = \frac{{θ}^{j + 1 , k + 1} - {θ}^{j + 1 , k}}{Δ t} + \frac{{θ}^{j + 1 , k} - {θ}^{j}}{Δ t}$$

$$( C + {βμ}_{s} ) \frac{\partial h}{\partial t} = \frac{{θ}^{j + 1 , k} - {θ}^{j}}{{h}^{j + 1 , k} - {h}^{j}} \frac{{h}^{j + 1 , k} - {h}^{j}}{Δ t} + {βμ}_{s} \frac{{h}^{j + 1 , k} - {h}^{j}}{Δ t} + o ( Δ t )$$

θ is the moisture content, cm³·cm⁻³; h is the soil negative pressure, cm; tis the time, min; C (h) is the water capacity when the soil negative pressure is h, cm³·cm⁻³; k is the number of iterations; u is the elastic water release coefficient; B is the adjustment coefficient.

The first term of the formula is the water content change rate between adjacent iteration levels, and the second term is the water content change rate between the current time and the previous time. This discrete expression represents the change of water content in time, but it is not absolutely mass conservative, because in the actual model operation, there is an iteration closure error (iteration allowable error), and the greater the closure error, the greater the mass error. The formula uses the secant method to calculate the water capacity, if it converges (h^{j+1,k+1}=h^{j+1,k}), the mass is conserved. This method is more accurate than the former, but it is not easy to form a matrix to solve. Both the first term of the formula and the second term of the equation imply the iterative formula, which indicates that this kind of hybrid iterative model can only be used in the iterative model, and is not applicable to the non-iterative model, so the computational cost and stability are issues that need to be concerned.

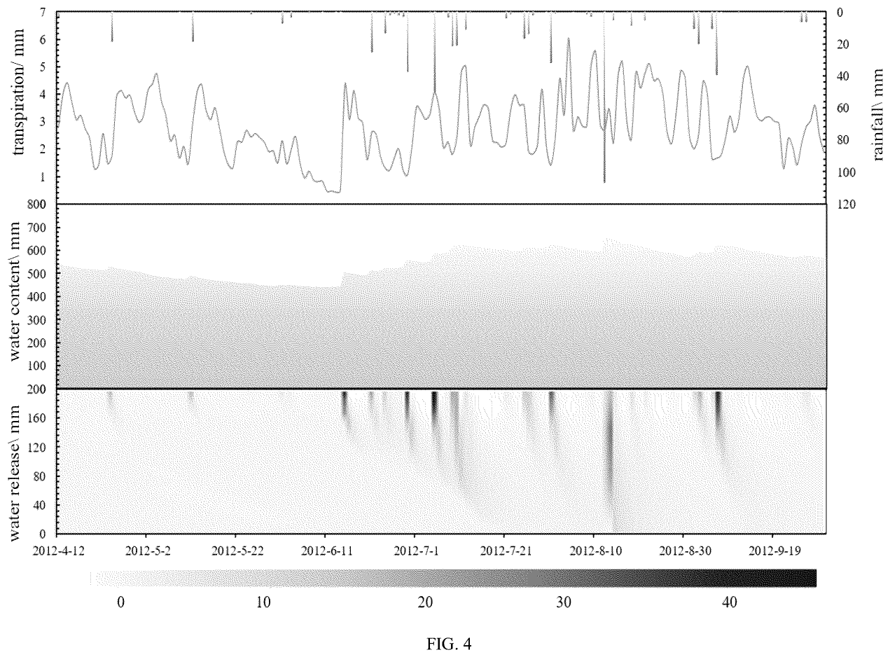

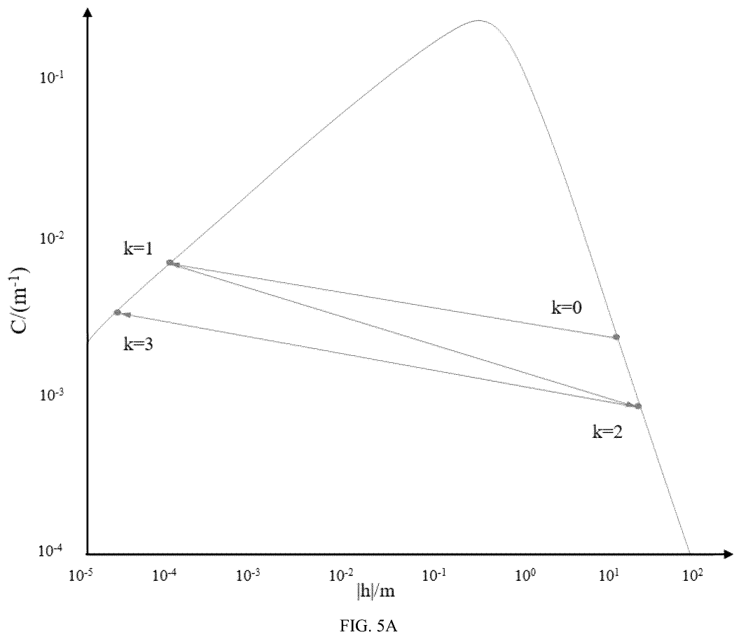

The PINNs algorithm, as a mesh-free algorithm with embedded physical knowledge and data-driven, effectively avoids the solution error caused by the spatial-temporal discrete operation. Physical laws (including but not limited to partial differential equations, but also including integral equations, stochastic partial differential equations, energy conservation relations, mass conservation relations, etc.) are embedded in the construction of neural network loss function, and as the network is trained together, we do not need to perform spatial-temporal discretization during the differentiation process. Instead, Back Propagation or Automatic Differentiation can be performed according to the properties of the neural network to analytically and accurately determine the derivatives of each order. Further analysis of the simulation results of the model verification period (from Apr. 12, 2012 to Sep. 30, 2012) obtained by the PINNs algorithm shows that, taking the soil column layer in the 2 m deep root zone as an example, as shown in FIG. 4, the total water input during the simulation period is 887.5 mm, including 370 mm of irrigation and 517.5 mm of precipitation. Compared with the initial stage of the simulation, the soil water storage increased by 30.78 mm. Among the items of water excretion, the crop transpiration is 420.8 mm, the surface soil evaporation is 188.61 mm, and the deep seepage is 247.32 mm.

### 2) Dry Soil Infiltration Problem

Soil is often affected by rainfall and evaporation alternately, so the problem of dry soil infiltration problem is often encountered in the simulation of saturated and unsaturated zones. Many traditional numerical simulation practices show that the model based on water head (such as HYDRUS model) often encounters the phenomenon of non-convergence in the calculation of dry soil infiltration problem due to improper spatial-temporal discretization. Even if the simulation converges, there will be a large simulation error (rounding error and truncation error). Taking the finite difference method as an example, when rainfall occurs (ignoring the evaporation between rains), the discrete formula of the water quantity at the first node on the soil surface is:

$${C}_{N}^{j + 1 , k} \frac{Δ {h}_{N}^{j + 1 , k}}{Δ t} = {P}_{p} - {q}_{N - \frac{1}{2}}^{k}$$

Wherein, k is the number of iterations; j is a constant used to mark time; N is the spatial node; h is the soil negative pressure, C_{N} is the soil surface node water capacity; Pₚ is the rainfall intensity;

$${q}_{N - \frac{1}{2}}^{k}$$

is the Darcy flux between the N-1 node and n node (positive downward). When the soil is very dry (k=0),

$${q}_{N - \frac{1}{2}}^{k}$$

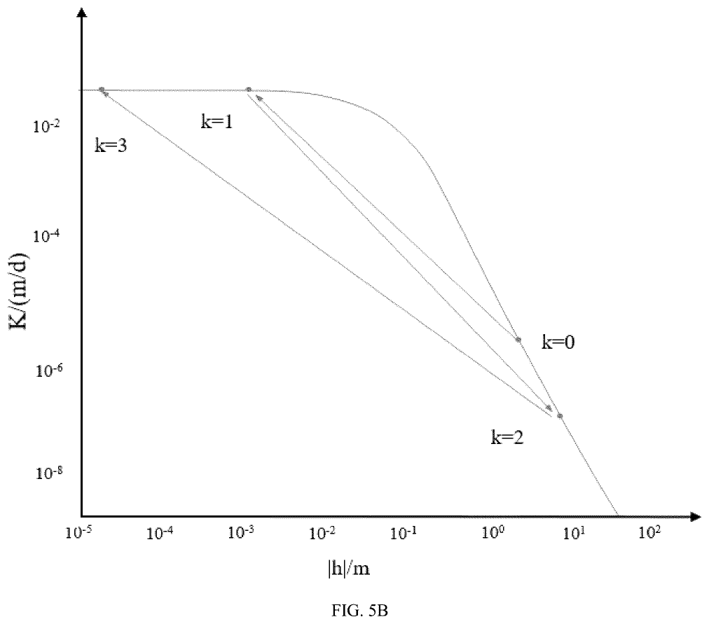

is negligible because the hydraulic conductivity of the soil surface nodes is small. At the same time, due to the extremely small water capacity, small rainfall can cause a large change in the surface soil water head. After one iteration (k=1), the soil is close to saturation, and the water capacity does not increase significantly due to the bell-shaped curve, but the hydraulic conductivity can increase by 5 orders of magnitude. Therefore, all rainfall can enter the second node, which leads to no significant change in the water head of the first node of the soil layer at the next moment. This iterative calculation makes the water content of topsoil jump repeatedly between the dry pole and the wet pole, which makes it difficult for the model to converge. The iterative process is shown in FIG. 5A and FIG. 5B. Even if the model is convergent, the water head gradient at the infiltration front can reach 103˜108 m/m in the infiltration problem. Such a high gradient will produce a large error when the difference scheme is used to approximate the spatial differentiation. Unless a variable grid is used (that is, the grid is refined at different places with the movement of the wetting front), a very fine grid is needed to control the spatial discretization error, but this often results in reduced computational cost and stability.

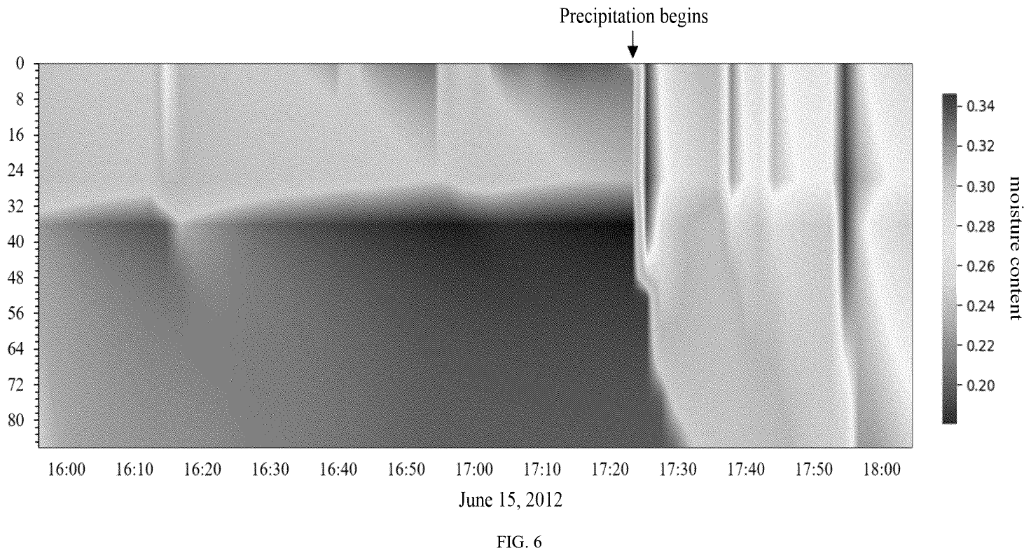

In this example, the PINNs algorithm successfully simulated the dry soil infiltration process, and the simulation results are shown in FIG. 6. For PINNs algorithm, due to the ability of FNN network to approximate complex functions and AD automatic differentiation mechanism, compared with numerical differentiation, it does not need to discretize the spatial-temporal domain, and the training or prediction of the model can be attributed to the optimization problem of solving the loss function. The inherent AD mechanism is essentially a combination of a series of finite differentiable operators, which is based on the fact that every computer program, no matter how complex it is, is performing a series of basic arithmetic operations such as addition, subtraction, multiplication and division, as well as elementary function operations such as exponential, logarithmic and trigonometric functions. Therefore, the AD mechanism first applies the symbolic differentiation method to the most basic operators, such as constants, power functions, exponential functions, logarithmic functions, trigonometric functions, etc., then substitutes the numerical values, retains the intermediate results, and finally applies it to the whole function through the chain derivation rule, so it can automatically calculate the derivative with arbitrary precision, and at most only one more constant level operation than the original program. From the overall simulation effect, although the application of PINNs algorithm will increase the memory consumption of solving Richards equation (due to the storage of intermediate derivative results), its accuracy is relatively high, because it uses a way similar to directed graph to calculate the differential value, without the problem of expression expansion and the mismatch of discrete space-time domain scale.

In a specific embodiment, the method of the present disclosure is verified with a one-dimensional transient unsaturated seepage analytical solution; the effectiveness of the PINNs algorithm for solving the Richards equation is verified by comparing the results of the actual solution with the analytical solution. It is assumed that the thickness of the soil layer is L=10 m, and the soil parameters are set as: a=110-4, θₛ=0.50, θᵣ=0.11, and Kₛ=910-5 m/s. The simulation time is 5 H, and the boundary conditions can be expressed as:

h(t,z=0)=h₀,t≥0

h(t,z=L)=0,t≥0

Letting h₀=−105 m, the analytical solution of this transient unsaturated flow problem is:

$${h}_{ana} ( z , t ) = \frac{1}{α} ln [ {h}_{t}^{*} ( z , t ) + {h}_{s}^{*} ( z ) + {e}^{α {h}_{0}} ]$$

$$Wherein ,$$

$${h}_{t}^{*} ( z , t ) = \frac{2 ( 1 - {e}^{α {h}_{0}} )}{Lc} {e}^{α ( L - z ) / 2} {\sum }_{k = 1}^{∞} {( - 1 )}^{k} ( \frac{{λ}_{k}}{{μ}_{k}} ) sin ( {λ}_{k} z ) {e}^{- {u}_{k} t}$$

$${h}_{s}^{*} ( z ) = ( 1 - {e}^{α {h}_{0}} ) ( 1 - {e}^{- α z} ) / ( 1 - {e}^{- α L} )$$

$$Wherein , {λ}_{k} = k π / L {μ}_{k} = ( {α}^{2} / 4 + {λ}_{k}^{2} ) / cc = α ( {θ}_{s} - {θ}_{r} ) / {k}_{s}$$

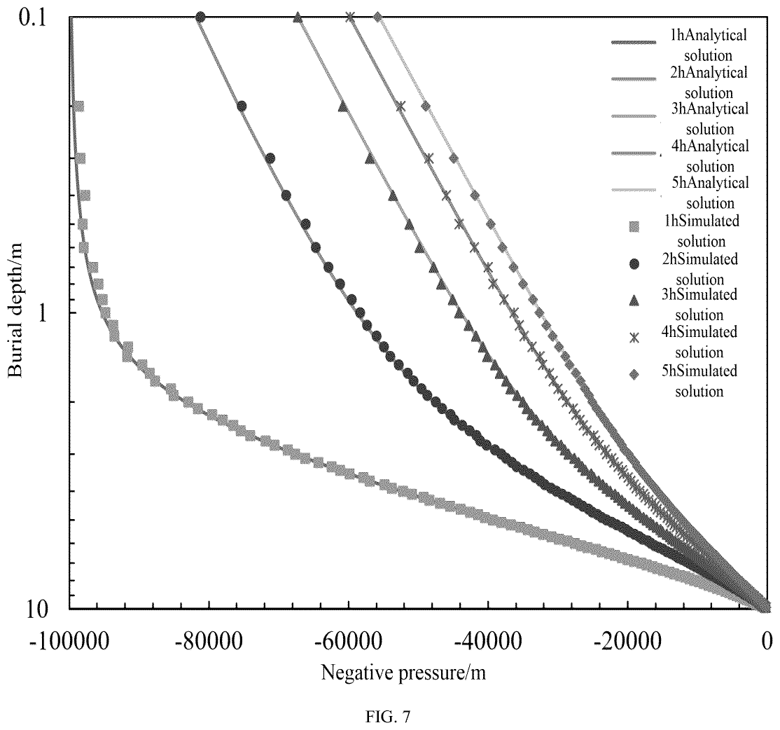

As shown in FIG. 7, the simulation solution obtained by the PINNs algorithm is very consistent with the analytical solution, and the NS coefficient in each period is above 0.97, and with the increase of simulation time, the relative error is gradually reduced, indicating that the PINNs algorithm can better simulate the one-dimensional transient unsaturated seepage problem in homogeneous unsaturated soil.

On the other hand, a system for constructing a soil water movement model based on the physical information neural networks is provided, which includes the following modules:
an equation construction module, which is configured to construct a conventional partial differential equation with constraint conditions and a Richards equation of a one-dimensional soil hydrodynamics model;
a solving module, which is configured to output an approximate solution of the partial differential equation by utilizing a feedforward neural network;
a residual network acquisition module, which is configured to substitute the approximate solution into the Richards equation through arithmetic operation and automatic differentiation to obtain a residual network;
an evaluation module, which is configured to introduce mean-square error (MSE) to characterize the loss function to evaluate the degree of agreement of the approximate solution to the Richards equation, boundary conditions and measured points; and
a model output module, which is configured to adopt a one-dimensional soil hydrodynamics model based on the Richards equation with minimum loss function.

Various embodiments of the present specification are described in a progressive manner, and each embodiment focuses on the description that is different from the other embodiments, and the same or similar parts between the various embodiments are referred to with each other. For the device disclosed in the embodiment, since ist corresponds to the method disclosed in the embodiment, the description is relatively simple, and the correlation is described with reference to the method part.

The above description of the disclosed embodiments enables those skilled in the art to implement or use the present disclosure. Various amendments to the embodiments will be apparent to those skilled in the art. The general principles defined herein may be implemented in other embodiments without departing from the spirit or scope of the disclosure. Therefore, the present disclosure will not be limited to the embodiments shown herein but is to be accorded the widest scope consistent with the principles and novel features disclosed herein.

What is claimed is:

1. A method for constructing a soil water movement model based on physical information neural networks, comprising:
constructing a conventional partial differential equation with constraint conditions and a Richards equation of a one-dimensional soil hydrodynamics model;
outputting an approximate solution of the conventional partial differential equation by utilizing a feedforward neural network;
substituting the approximate solution into the Richards equation through arithmetic operation and automatic differentiation to obtain a residual network;
introducing mean-square error (MSE) to characterize a loss function to evaluate a degree of an agreement of the approximate solution to the Richards equation, boundary conditions, and measured points; and
adopting a one-dimensional soil hydrodynamics model based on the Richards equation with a minimum loss function;
the Richards equation for the one-dimensional soil hydrodynamics model is
$$C ( h ) \frac{\partial h}{\partial t} = \frac{\partial }{\partial z} [ K ( h ) \frac{\partial h}{\partial z} ] - \frac{\partial K ( h )}{\partial h} \frac{\partial h}{\partial z} - S$$
$$h ( 0 , z ) = {h}_{0} ( z ) , t = 0 , z ⩾ 0$$
$$- K ( h ) \frac{\partial h}{\partial z} + K ( h ) = - ε ( t ) , t > 0 , z = 0$$
$$h ( t , {z}_{0} ) = {h}_{zmax} ( t ) , t > 0 , {z}_{0} = z max$$
wherein h is a soil negative pressure, cm; t is time, min; C(h) is a water capacity when the soil negative pressure is h, cm³·cm⁻³; K(h) is corresponding water conductivity, cm/min; intensity of an upper boundary flux is ε(t), cm/min; S is a source-sink term and water absorption intensity of a root system at different spatial nodes, and S is a function of a spatial location node and the soil negative pressure h, cm/min; z represents a depth of the spatial node, z max indicates a maximum buried depth, cm; h₀(z) indicates an initial negative pressure of a soil profile, cm; and h_{zmax} (t) indicates a negative pressure of a soil profile at a maximum burial depth, cm;
an expression of the loss function is constructed by the Richards equation, the boundary conditions and the measured points through the automatic differentiation:
$$ℒ ( \prod ) = \frac{1}{{N}_{u}} {ω}_{u} {\sum }_{i = 1}^{3} {\sum }_{x ∈ {N}_{u}} {‖ {ℬ}_{i} ( \hat{u} , x ) ‖}_{2}^{2} + \frac{1}{{N}_{f}} {ω}_{f} {\sum }_{x ∈ {N}_{f}} {‖ f ( x ; \frac{\partial u}{\partial {x}_{1}} , … , \frac{\partial u}{\partial {x}_{d}} ; \frac{{\partial }^{2} u}{\partial {x}_{1} \partial {x}_{1}} , … , \frac{{\partial }^{2} u}{\partial {x}_{1} \partial {x}_{d}} ; … ; λ ) ‖}_{2}^{2} + \frac{1}{{N}_{i}} {ω}_{i} {\sum }_{x ∈ {N}_{i}} {‖ ℒ ( \hat{u} , x ) ‖}_{2}^{2}$$
wherein [symbol] ᵤ represents a weight of a modified boundary condition loss function; [symbol] _{b} represents a weight of a modified main control equation loss function; [symbol] ᵢ represents a weight of measured sample point loss functions; B={B₁ (Ū_{NN},Z,t),B₂ (Ū_{NN},Z,t), B₃ (Ū_{NN},z,t)}; [symbol] ₁ (Ū_{NN},Z,t)=Ū_{NN} (z, 0)−h (z, 0) is an initial condition of a control equation, [symbol] ₂ (Ū_{NN},Z,t)=−K(h)∂h(Ū_{NN}, t)/∂z+K (h)+ε(t) is an upper flux boundary condition of the control equation, and [symbol] ₃ (Ū_{NN}, Z, t)=Ū_{NN} (zmax, 0)−h (zmax, 0) is a lower flux boundary condition of the control equation; Nᵤ represents a set of residual points u for training a neural network in a boundary and N_{f} represents a set of residual points for training a neural network in a calculation area, Nᵤ and N_{f} are selected by random sampling, and Nᵢ is a set composed of measured data;
the obtained residual network is as follows:
$${f}_{NN} ( x ; \prod ) = f ( x ; \frac{\partial {u}_{NN}}{\partial {x}_{1}} , … , \frac{\partial {u}_{NN}}{\partial {x}_{d}} , \frac{{\partial }^{2} {u}_{NN}}{\partial {x}_{1} \partial {x}_{1}} , … , \frac{{\partial }^{2} {u}_{NN}}{\partial {x}_{1} \partial {x}_{d}} ; … )$$
wherein x=(x₁, x₂, . . . , xₐ) represents a variable of the conventional partial differential equation, u is a solution of the conventional partial differential equation; U_{NN} is a partial derivative of g, and u(x) satisfies the boundary condition: [symbol]
(u,x)=0,x∈∂Ω

2. The method for constructing the soil water movement model based on the physical information neural networks according to claim 1, wherein a step of simplifying the Richards equations of the one-dimensional soil hydrodynamics model into partial differential equations by utilizing a Van Genuchten model is further comprised;
the Richards equation is simplified by utilizing the Van Genuchten model to only involve partial derivatives of the soil negative pressure, and a final physical informed neural networks (PINNs) form of the Richards equation is expressed as follows:
$$f ( z , t ; \frac{\partial h}{\partial z} , \frac{\partial h}{\partial t} , \frac{{\partial }^{2} h}{\partial {z}^{2}} ; λ ) = C \frac{\partial h}{\partial t} - \frac{\partial K}{\partial h} {( \frac{\partial h}{\partial z} )}^{2} - K \frac{{\partial }^{2} h}{\partial {z}^{2}} - \frac{\partial K}{\partial h} \frac{\partial h}{\partial z} + S = 0$$
wherein h is the soil negative pressure, cm; t is the time, min; C(h) is the water capacity when the soil negative pressure is h, cm³·cm⁻³; K(h) is the corresponding water conductivity, cm/min; the intensity of the upper boundary flux is ε(t), cm/min; S is the source-sink term and the water absorption intensity of the root system at the different spatial nodes, and S is the function of the spatial location node and the soil negative pressure h, cm/min; z represents the depth of the spatial node, and X=[Kₛ, θₛ, θᵣ, a, n]^{T} is a parameter vector of a parameterized Richards equation; θ_{S} is saturation volume moisture content, cm³·cm⁻³; θᵣ is residual moisture content, cm³·cm⁻³; K is unsaturated hydraulic conductivity, cm/min; Kₛ is saturation hydraulic conductivity, cm/min; Se is a saturation degree, cm³·cm⁻³; and n is a soil texture parameter.

3. The method for constructing the soil water movement model based on the physical information neural networks according to claim 2, wherein the Van Genuchten model is expressed as follows:
$$Se ( θ ) = \{ \begin{matrix}1 & h ( θ ) \geq 0 \\ {\{ 1 + {[ {α}_{VG} \vert h \vert ]}^{n} \}}^{- m} & h ( θ ) < 0\end{matrix}$$
$$K ( θ ) = {K}_{s} \sqrt{Se ( θ )} {\{ 1 - {[ 1 - {Se}^{\frac{1}{m}} ( θ ) ]}^{m} \}}^{2}$$
$$θ ( h ) = {θ}_{r} + \frac{{θ}_{s} - {θ}_{r}}{{( 1 + {( - {α}_{VG} h )}^{n} )}^{m}}$$
$$Se ( θ ) = \frac{θ - {θ}_{r}}{{θ}_{s} - {θ}_{r}}$$
wherein h is the soil negative pressure, cm; θ is moisture content, cm³·cm⁻³; θₛ is the saturation volume moisture content, cm³·cm⁻³; θᵣ is the residual moisture content, cm³·cm⁻³; K is the unsaturated hydraulic conductivity, cm/min; Kₛ is the saturation hydraulic conductivity, cm/min; Se is the saturation degree, cm³·cm⁻³; a_{VG} is a shape parameter of the Van Genuchten model, and a_{VG} represents a pore size distribution of a soil, cm⁻¹, and n is the soil texture parameter, m=1−1/n.

4. The method for constructing the soil water movement model based on the physical information neural networks according to claim 1, wherein a calculation principle of the automatic differentiation is as follows: decomposing a complex analytic function into a series of elementary operation combinations, performing a derivation through symbolic differentiation, substituting related values, storing intermediate results through a computer, and finally obtaining an expected derivative value by utilizing a chain rule.

5. A system for constructing a soil water movement model based on physical information neural networks, comprising:
an equation construction module, configured to construct a conventional partial differential equation with constraint conditions and a Richards equation of a one-dimensional soil hydrodynamics model;
a solving module, configured to output an approximate solution of the conventional partial differential equation by utilizing a feedforward neural network;
a residual network acquisition module, configured to substitute the approximate solution into the Richards equation through arithmetic operation and automatic differentiation to obtain a residual network;
an evaluation module, configured to introduce MSE to characterize a loss function to evaluate a degree of an agreement of the approximate solution to the Richards equation, boundary conditions, and measured points; and
a model output module, configured to adopt a one-dimensional soil hydrodynamics model based on the Richards equation with a minimum loss function;
the Richards equation for the one-dimensional soil hydrodynamics model is
$$C ( h ) \frac{\partial h}{\partial t} = \frac{\partial }{\partial z} [ K ( h ) \frac{\partial h}{\partial z} ] - \frac{\partial K ( h )}{\partial h} \frac{\partial h}{\partial z} - S$$
$$h ( 0 , z ) = {h}_{0} ( z ) , t = 0 , z ⩾ 0$$
$$- K ( h ) \frac{\partial h}{\partial z} + K ( h ) = - ε ( t ) , t > 0 , z = 0$$
$$h ( t , {z}_{0} ) = {h}_{zmax} ( t ) , t > 0 , {z}_{0} = z max$$
wherein h is a soil negative pressure, cm; t is time, min; c(h) is a water capacity when the soil negative pressure is h, cm³·cm⁻³; K(h) is corresponding water conductivity, cm/min; intensity of an upper boundary flux is ε(t), cm/min; S is a source-sink term and water absorption intensity of a root system at different spatial nodes, and S is a function of a spatial location node and the soil negative pressure h, cm/min; z represents a depth of the spatial node, z max indicates a maximum buried depth, cm; h₀(z) indicates an initial negative pressure of a soil profile, cm; and h_{zmax} (t) indicates a negative pressure of a soil profile at a maximum burial depth, cm;
an expression of the loss function is constructed by the Richards equation, the boundary conditions and the measured points through the automatic differentiation:
$$ℒ ( \prod ) = \frac{1}{{N}_{u}} {ω}_{u} {\sum }_{i = 1}^{3} {\sum }_{x ∈ {N}_{u}} {‖ {ℬ}_{i} ( \hat{u} , x ) ‖}_{2}^{2} + \frac{1}{{N}_{f}} {ω}_{f} {\sum }_{x ∈ {N}_{f}} {‖ f ( x ; \frac{\partial u}{\partial {x}_{1}} , … , \frac{\partial u}{\partial {x}_{d}} ; \frac{{\partial }^{2} u}{\partial {x}_{1} \partial {x}_{1}} , … , \frac{{\partial }^{2} u}{\partial {x}_{1} \partial {x}_{d}} ; … ; λ ) ‖}_{2}^{2} + \frac{1}{{N}_{i}} {ω}_{i} {\sum }_{x ∈ {N}_{i}} {‖ ℒ ( \hat{u} , x ) ‖}_{2}^{2}$$
wherein [symbol] ᵤ represents a weight of a modified boundary condition loss function; [symbol] _{b} represents a weight of a modified main control equation loss function; [symbol] ᵢ represents a weight of measured sample point loss functions; B={B₁ (Ū_{NN},Z,t), B₂ (Ū_{NN}, Z,t), B₃ (Ū_{NN}, z,t)}; [symbol] ₁ (Ū_{NN},Z,t)=Ū_{NN} (z, 0)−h(z, 0) is an initial condition of a control equation, [symbol] ₂ (Ū_{NN},Z,t)=−K(h)∂h(Ū_{NN}, t)/∂z+K(h)+ε(t) is an upper flux boundary condition of the control equation, and [symbol] ₃ (Ū_{NN}, Z,t)=Ū_{NN} (zmax, 0)−h (zmax, 0) is a lower flux boundary condition of the control equation; Nᵤ represents a set of residual points for training a neural network in a boundary and N_{f} represents a set of residual points for training a neural network in a calculation area, Nᵤ and N_{f} are selected by random sampling, and Nᵢ is a set composed of measured data;
the obtained residual network is as follows:
$${f}_{NN} ( x ; \prod ) = f ( x ; \frac{\partial {u}_{NN}}{\partial {x}_{1}} , … , \frac{\partial {u}_{NN}}{\partial {x}_{d}} , \frac{{\partial }^{2} {u}_{NN}}{\partial {x}_{1} \partial {x}_{1}} , … , \frac{{\partial }^{2} {u}_{NN}}{\partial {x}_{1} \partial {x}_{d}} ; … )$$
wherein x=(x₁, x₂, . . . x_{d}) represents a variable of the conventional partial differential equation, u is a solution of the conventional partial differential equation; U_{NN} is a partial derivative of g, and u(x) satisfies the boundary condition: [symbol]
(u,x)=0, x∈∂Ω.
